(19) United States
(12) Patent Application Publication
(10) Pub. No.: US 2005/0212921 A1
(43) Pub. Date: Sep. 29, 2005

(54) Camera system

(75) Inventor: Hirofumi Horii, Asaka (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co., Ltd., Kanagawa (JP)

(21) Appl. No.: 11/086,741

(22) Filed: Mar. 23, 2005

(30) Foreign Application Priority Data
Mar. 29, 2004 (JP) 2004-094925

(51) Int. Cl. H04N 5/232

(52) U.S. Cl. 348/211.14

(57) ABSTRACT

The present invention provides a camera system having a communication interface that allows efficient transmission of a through image signal and reduction of power consumption. A Y-frames/s conversion section is provided in a high-rate communication section of a camera head. Once a through image signal is read from a high resolution CCD 12a, the through image signal is supplied to a display device after the frame rate is converted from X frames/s to Y frames/s, which is lower than X frames/s, in the Y-frames/s conversion section of the high-rate communication section.

### BACKGROUND OF THE INVENTION

1. Field of the Invention

The present invention relates to a camera system including: a camera head which has an image taking optical system and an image pickup device; and a camera main unit to which the camera head is removably attached and which receives an image signal from the camera head and performs a signal processing.

2. Description of the Related Art

There has been proposed a camera system including a camera main unit and a plug-in unit incorporating an image pickup device and an image taking optical system integrally, in which, once the plug-in unit is attached to the camera main unit, information retained in the plug-in unit is transmitted to the camera main unit to enable image taking using the image taking optical system of the plug-in unit (see Japanese Patent Laid-Open No. 8-172561). Such a camera system, whose image taking optical system, that is, the image taking lens, can be changed simply by attaching the plug-in unit to the camera main unit, is quite easy to handle and permits a person who has no expertise in camera system to easily change the image taking lens.

There has been proposed a similar camera system including: a camera head having an image taking optical system and an image pickup device; and a camera main unit to which the camera head is removably attached and which receives an image signal from the camera head through interface and performs a signal processing (see Japanese Patent Laid-Open No. 2000-50130).

The rate of reading image signals from an image pickup device (referred to as frame rate, hereinafter) is typically 30 fps (frames per second). This is the same as the frame rate of the broadcast signal or the like, and the frame rate of 30 fps is enough for images switched on the display screen to be recognized as a moving image by the human eye. Many cameras having such an image pickup device perform exposure or focus adjustment using the image taking lens, and the exposure or focus adjustment is typically performed on a frame-rate basis. However, if the focus or exposure adjustment is performed on a frame-rate basis in this way, when the image taking lens is aimed at a different object, a blurred object image may be displayed on the display screen for about 1 second or an object image taken under a wrong exposure condition may be displayed on the display screen. To avoid such circumstances, an image pickup device may be used which can read the image signal at a high frame rate on the order of 300 fps and quickly performs focus or exposure adjustment.

Even if the frame rate is increased in this way, a typical camera can adjust the processing rate of the signal processing section to the higher frame rate by using a buffer. However, in the case of camera systems whose camera head and camera main unit are separated from each other, such as ones disclosed in Japanese Patent Laid-Open Nos. 8-172561 and 2000-50130, a communication interface is interposed between the camera main unit and the camera head, and therefore, the frame rate of the image signal and the processing rate of the signal processing section as well as the communication rate of the communication interface have to be matched to each other.

In this case, in order to accommodate the differences among the frame rate, the communication rate and the signal processing rate, any image signals may be once transmitted from the camera head to the camera main unit at a communication rate equal to the frame rate, and the transmitted image signals may be stored in the buffer of the main unit.

However, in this case, the image signal to display the object image on the display screen (referred to as a through image signal, hereinafter) is transmitted from the camera head to the camera main unit at the higher frame rate described above, and thus, there is a problem that the power consumption of the battery increases accordingly. Furthermore, there is another problem that the increase of power consumption causes the communication interface to produce more radiation noise. As described above, the through image signal can be adequately transmitted from the camera head to the camera main unit at the frame rate of 30 fps.

### SUMMARY OF THE INVENTION

The present invention has been made in view of the above circumstances and provides a camera system having a camera head that can transmits a through image signal with a reduced power consumption.

A camera system according to the present invention includes: a camera head having an image taking optical system and an image pickup device; and a camera main unit to which the camera head is removably attached and which receives an image signal from the camera head and performs a signal processing,
in which the camera head has a signal reading section that reads an image signal from the image pickup device at a predetermined first frame rate and a signal transmission section that transmits the image signal to the camera main unit at a predetermined second frame rate that is lower than the first frame rate.

When transmitting a through image signal in this way, the image signal read at the predetermined first frame rate is transmitted to the camera main unit after the frame rate is reduced to the second frame rate. The reduction of frame rate results in suppression of the increase of power consumption of the battery, which is conventionally caused by the through image signal being transmitted to the camera main unit at the same frame rate as the first frame rate. Furthermore, the suppression of the increase of power consumption of the battery results in suppression of occurrence of radiation noise from an interface.

In addition, according to the present invention, the camera head has a calculation section that performs at least one of exposure adjustment and focus adjustment based on the image signal read by the signal reading section at the first frame rate, and
the camera main unit has an image display section that displays an image based on the image signal transmitted by the signal transmission section at the second frame rate.

If exposure or focus is adjusted quickly based on the image signal read by the signal reading section at the first frame rate in this way, exposure or focus adjustment is performed quickly at the first frame rate, the image signal whose exposure or focus is adjusted is transmitted to the camera main unit at the second frame rate, and an image based on the image signal is displayed on the display device as a through image. Therefore, a highly sharp through image can be displayed on the display screen.

Further, the camera main unit has plural types of image display sections that display an image based on the image signal transmitted from the signal transmission section and a display section switching section that selects one of plural types of image display sections for displaying the image, and
the signal transmission section transmits the image signal at the second frame rate, which is suitable for the image display section for displaying the image selected by the display section switching section.

If plural types of image display sections are two types of image display sections, for example, a viewfinder and a LCD panel, the signal transmission section transmits the image signal to the viewfinder at the second frame rate suitable for the viewfinder and transmits the image signal to the LCD panel at the second frame rate suitable for the LCD panel.

It is preferred that the signal transmission section transmits the image signal read by the signal reading section at the same rate as the reading rate of the signal reading section by thinning out the image signal on a frame basis.

In this case, when transmitting a through image signal, an image signal can be read by the signal reading section from the image pickup device at the predetermined first frame rate, and the through image signal can be transmitted at the predetermined second frame rate lower than the first frame rate, and when transmitting a static image signal obtained by an image-taking operation to the camera main unit, an image signal can be read by the signal reading section from the image pickup device at the predetermined first frame rate, and the static image signal can be transmitted to the camera main unit at the first frame rate in a short time.

In addition, it is preferred that the signal transmission section has a buffer that thins out on the frame basis and buffers the image signal read by the signal reading section and transmits the image signal buffered in the buffer at a rate lower than the rate of reading of the image signal by the signal reading section.

In this case, given that the first frame rate is 300 fps, for example, an image signal can be read at the frame rate of 300 fps, one frame in every ten frames of the image signal can be buffered in the buffer, and the buffered image signal can be transmitted to the camera main unit from the signal transmission section after the frame rate is converted to a lower rate of 30 fps, for example.

As described above, there is provided a camera system having a camera head that can transmit a through image signal with a reduced power consumption.

### BRIEF DESCRIPTION OF THE DRAWINGS

FIG. 1 shows a camera system according to an embodiment of the present invention;

FIG. 2 is a block diagram showing an electric system of a camera main unit 1b and a camera head 1a attached to the camera main unit 4;

FIG. 3 is a schematic diagram showing how an image signal produced in the camera head is transferred from the camera head to the camera main unit;

FIG. 4 shows another embodiment; and

FIG. 5 is a flowchart showing a procedure of a processing performed by a main unit CPU 100b.

### DETAILED DESCRIPTION OF THE INVENTION

In the following, embodiments of the present invention will be described.

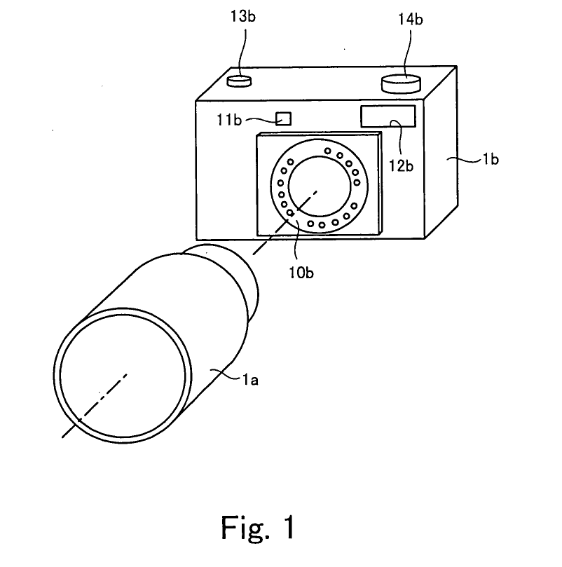

FIG. 1 shows a camera system according to an embodiment of the present invention.

As shown in FIG. 1, a camera system 1 according to this embodiment has a camera head 1a and a camera main unit 1b. The camera head 1a shown in FIG. 1 has an image taking optical system and an image pickup device and is removably attached to the camera main unit 1b, and the camera main unit 1b shown in FIG. 1 receives an image signal from the camera head 1a and performs signal processing.

Viewed from the outside, the camera head 1a is similar to conventional interchangeable lenses.

The camera main unit 1b has, in the middle thereof, a head mount 10b with multiple mount contacts. The camera head 1a also has a similar mount section. Once the camera head 1a is attached to the camera main unit 1b along the chain line in the drawing with the positions of the mount contacts of the mounts adjusted to each other, each of the mount contacts of one mount is connected to a corresponding one of the other mount, and thus, the camera head 1a and the camera main unit 1b are electrically connected to each other.

Each of the multiple mounts serves for communication or power supply and allows communication from the camera main unit 1b to the camera head 1a, communication from the camera head 1a to the camera main unit 1b, or power supply from the camera main unit 1b to the camera head 1a.

Above the head mount 10b, there is disposed an AWB sensor 11b, which detects the type of the light source used for image taking. The type of the light source may be sunlight or a fluorescent light, for example. Once the AWB sensor 11b detects the type of the light source, an appropriate color temperature is set in a digital signal processing section, described later, and optimum white balance adjustment is performed. A flash light emitting window 12b is disposed at the side of the AWB sensor 11b, and a flash light emitting device that emits flash light through the flash light emitting window 12b is incorporated in the camera main unit 1b. Furthermore, the camera main unit 1b has a release button 13b and a mode dial 14b on the top surface thereof. The mode dial 14b permits selection between an image taking mode and a replay mode and further selection between a static image taking mode and a moving image taking mode in the image taking mode. Here, FIG. 1 shows one of multiple possible camera heads and one of multiple possible camera main units, for the sake of illustration.

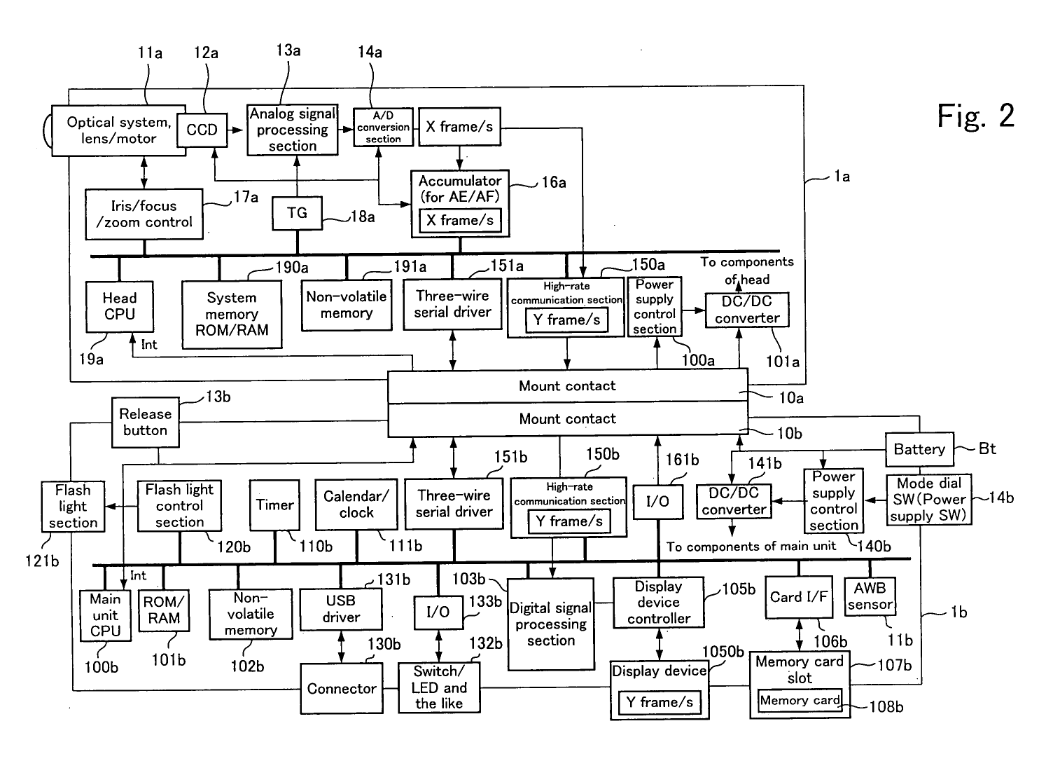

Now, referring to FIG. 2, an internal arrangement of the camera head 1a and the camera main unit 1b will be described.

FIG. 2 is a block diagram showing an arrangement of an electric system of the camera head 1a and the camera main unit 1b to which the camera head 1a is attached.

The upper part of FIG. 2 shows an arrangement of the camera head 1a, and the lower part of FIG. 2 shows an arrangement of the camera main unit 1b.

The camera head 1a of the camera system 1 according to this embodiment can operate only after it is attached to the camera main unit 1b and is supplied with electric power from a battery Bt in the camera main unit 1b. A DC/DC converter 101a of the camera head 1a, as well as a DC/DC converter 141b of the camera main unit 1b, is controlled by a power control section 140b of the camera main unit 1b. Once a power supply switch 14b, which is integrated with the mode dial 14b, is turned on, the battery Bt supplies electric power to the DC/DC converter 141b of the camera main unit 1b and the DC/DC converter 101a of the camera head 1a, and the electric power is supplied from the DC/DC converters 101a and 141b to other sections. In this way, the camera system is activated.

Now, an arrangement of the camera head 1a will be described.

As shown in FIG. 2, the camera head 1a of the camera system 1 has an image taking optical system 11a and an image pickup device (which is a CCD solid image pickup device in this example and therefore will be referred to as a CCD, hereinafter) 12a. The image taking optical system 11a incorporates an image taking lens, an iris and the like. The image taking lens in the image taking optical system 11a focuses an image of an object on the CCD 12a, and the CCD 12a produces image data. A pixel-based image signal produced by the CCD 12a is read by an analog signal processing section 13a at a predetermined first frame rate and is subject to a processing, such as noise reduction, in the analog signal processing section 13a. Then, the processed analog image signal is converted into a digital image signal by a subsequent A/D conversion section 14a, and the digital image signal is supplied to a high-rate communication section 150a. FIG. 2 shows that the image signal is read from the CCD 12a and transferred to the high-rate communication section 150a at a frame rate of X frames/s shown in the block subsequent to the A/D conversion section 14a. The frame rate of X frames/s corresponds to the predetermined first frame rate according to the present invention. In image signal reading from the CCD 12a at the predetermined first frame rate, according to this embodiment, a head CPU 19a controls a timing generator (abbreviated as TG, hereinafter) 18a and makes the TG 18a supply a reading signal to the CCD 12a at predetermined intervals. The TG 18a corresponds to a signal reading section according to the present invention. The TG 18a supplies reading signals to the CCD 12a so as to achieve the frame rate of X frames/s, which corresponds to the predetermined first frame rate.

In this way, the image signal read at the frame rate of X frames/s is supplied to the high-rate communication section. The image signals supplied to the camera main unit 1b via the high-rate communication section 150a include a through image signal, which is to display, on an LCD panel (not shown), an image of an object that is captured by the image taking lens in the image taking optical system when any of the image taking modes is selected via the mode dial 14b, and a static image signal, which is obtained through operation of the release button 13b when the static image taking mode is selected from among the image taking modes. Any of such image signals is transmitted to the camera main unit 1b through the high-rate communication section 150a in response to a request from the camera main unit 1b.

FIG. 2 shows a frame rate of Y frames/s in the block of the high-rate communication section 150a, which means that, in transmission of a through image signal, the through image signal read at the frame rate of X frames/s is transmitted to the camera main unit after the frame rate of X frames/s is changed to a predetermined second frame rate of Y frames/s, which is lower than X frames/s (X>Y). The high-rate communication section 150a, which transmits image signals at the predetermined second frame rate of Y frames/s that is lower than the first frame rate of X frames/s, corresponds to a signal transmission section according to the present invention. An arrangement of the signal transmission section will be described later. The image signals transmitted from the high-rate communication section 150a, serving as the signal transmission section, is received at a high-rate communication section 150b of the camera main unit.

On the other hand, the image signals of the higher frame rate of X frames/s are supplied not only to the high-rate communication section 150a but also to an accumulator circuit 16a, which provides an AF function (referred to simply as AF, hereinafter) and an AE function (referred to simply as AE, hereinafter). The accumulator 16a measures the luminance of field required to provide the AE function and the depth of field required to provide the AF function. The depth of field (a distance between an object and a camera) and the luminance of field measured by the accumulator circuit 16a are supplied to an iris/focus/zoom control section 17a via a data bus 192a, and the iris/focus/zoom control section 17a adjusts the diameter of the iris in the image taking optical system and the position of an focusing lens in the image taking optical system. With such an arrangement, each time the lens in the image taking optical system of the camera head 1a is aimed at a different object, the AF or AE immediately operates to adjust the focus or luminance, and the CCD 12a produces and outputs image data representing the object focused. In this example, image signals are read from the CCD at X frames/s and supplied to the accumulator every 1/X seconds for exposure or focus adjustment, and thus, highly precise exposure or focus adjustment can be achieved.

To accomplish processing at the frame rate, the TG 18a supplies the reading signal (a signal to achieve X frames/s) to all of the CCD 12a, the analog signal processing section 13a, the AD conversion section 14a and the accumulator 16a, so that the CCD 12a and the other sections operate in synchronization with the reading signal output from the TG 18a. The TG 18a and the iris/focus/zoom control section 17a operate under the control of the head CPU 19a according to a procedure specified by a program stored in a ROM of a system memory (ROM/RAM) 190a. Here, the ROM stores a program that specifies procedures of AE, AF and communication using a serial bus, for example. In addition, the ROM stores a through image processing program that is activated when the image taking mode is selected via the mode dial 14b, a static image processing program that is activated when the static image taking mode is selected, a moving image processing program that is activated when the moving image taking mode is selected, or the like.

In addition, a non-volatile memory 191a stores, in a non-volatile manner, ID information for identifying the camera head and signal processing information required for processing of image signals passed from the camera head 1a to the camera main unit 1b by the camera main unit 1b. When a command requesting for transmission of such information is transmitted to the camera head 1a from the camera main unit 1b via a three-wire serial bus, only the ID information in the non-volatile memory 191a is, or both the ID information and the signal processing information in the non-volatile memory 191a are, transmitted to the camera main unit 1b via the three-wire serial bus. The camera main unit 1b has a three-wire serial driver 151b for driving the three-wire serial bus, and the serial bus driven by both the three-wire serial driver 151b in the camera main unit 1b and a three-wire serial driver 151a in the camera head 1a allows command transmission from the camera main unit 1b to the camera head 1a or from the camera head 1a to the camera main unit 1b. For example, if the camera main unit 1b transmits a command requesting for transmission of ID information to the camera head 1a, in response to the command, the camera head 1a transmits ID information or signal processing information through the three-wire serial bus to the camera main unit 1b. Alternatively, if the camera main unit 1b communicates a command requesting for transmission of image signals to the camera head 1a, the camera head 1a transmits digital image signals to the camera main unit 1b through the high-rate communication section, which is faster than the three-wire serial bus.

An arrangement of the camera head has been described above.

Now, an arrangement of the camera main unit 1b will be described.

The operation of the camera main unit 1b is generally controlled by a main unit CPU 100b. The camera main unit 1b also has a ROM that stores a program, a RAM that serves as a work area used for processing according to a procedure specified by the program, a non-volatile memory 102b for storing, in a non-volatile and writable manner, ID information or signal processing information transmitted from the camera head 1a. A ROM in a ROM/RAM 101b, which is a system memory, stores a program that specifies a procedure of a main processing of the camera system, and the program also describes procedures of processing of a through image signal, a static image signal and a moving image signal in conjunction with the head CPU 19a in the camera head 1a.

The main unit CPU 100b controls command exchange through the three-wire serial bus, reception of image signals at the high-rate communication section 150b or the like according to the program stored in the ROM/RAM 101b. In order to show that the high-rate communication section 150b receives image signals transmitted from the camera head 1a at Y frames/s, FIG. 2 shows the frame rate of the transmitted image signals, that is, Y frames/s, in the block of the high-rate communication section 150b.

If the power supply switch 14b is turned on when the camera head 1a is attached to the camera main unit 1b, the main unit CPU 100b controls the three-wire serial driver 151b to transmit a command requesting for transmission of a through image signal to the camera head 1a through the serial bus driven by the three-wire serial driver 151b. In response to the request for transmission of a through image, the head CPU 19a of the camera head 1a causes transmission of the through image signal to the camera main unit 1b via the high-rate communication sections 150a and 150b. The through image signal is supplied to the camera main unit after the frame rate is changed from X frames/s to Y frames/s in the high-rate communication section 150a. When the through image signal is supplied to the camera main unit 1b in this way, the through image signal is received at the high-rate communication section 150b in the camera main unit, and the received through image signal is supplied to a digital signal processing section 103b. The digital signal processing section 103b performs a predetermined processing on the supplied through image signal, the through image signal having been subject to the processing is supplied to a display device controller 105b, and the display device controller 105b displays a through image on a display screen of a display device 1050b according to the through image signal. As shown in the drawing, the display device 1050b is also supplied with the through image signal at the frame rate of Y frames/s.

If the release button 13b is pressed down while the through image is being displayed, an interrupt signal int is supplied to both the main unit CPU 100b and the head CPU 19a to interrupt the processing of the through image, and the static image processing program stored in the ROM is activated by external interruption. As shown in FIG. 2, when the release button 13b is pressed down, a release signal is input directly to an external interrupt input pin of the main body CPU 100b and the head CPU 19a as the interrupt signal “int.” At the timing of the interruption caused by pressing of the release button 13b, the head CPU 19a in the camera head 1a makes the TG 18a supply a signal to start exposure to the CCD 12a, thereby making the CCD 12a start exposure. Then, the head CPU 19a makes the TG 18a supply a reading signal, as a signal to stop exposure, to the CCD 12a, thereby making the CCD 12a output a static image signal composed of all pixel data to the analog signal processing section 13a. The static image signal output to the analog signal processing section 13a is supplied to the digital signal processing section 103b through the A/D conversion section 14a and the high-rate communication section 150a, and a JPEG file, which is obtained by compressing the static image signal in JPEG format in the signal processing section 103b, is stored, via a card I/F 106b, in a memory card 108b loaded in a memory card slot 107b. In this case, the frame rate conversion from X frames/s to Y frames/s is not performed, and the static image signal is supplied to the camera main unit at the frame rate of X frames/s.

If the mode dial 14b is set at the moving image mode, manipulation of the release button 13b causes interruption to activate the moving image processing program. Moving image signals are supplied to the digital signal processing section 103b through the high-rate communication sections 150a and 150b at predetermined intervals of time and compressed in motion-JPEG or MPEG format, and the resulting data is stored in the memory card 108b.

The camera system has a timer 110b for timer processing and a calendar/clock section 111b, while they do not directly relate to the present invention. For example, calendar data is supplied from the calendar/clock section to the display device controller 105b, a clock or calendar image is displayed along with the object image on the panel of the display device 1050b. Furthermore, the camera main unit 1b has a USB connector 130b. If a personal computer or the like is connected to the camera main unit 1b via the USB connector 130b, a USB driver 131b drives a USB, and image signals are transferred to the personal computer. In addition, the flash light emitting device composed of a flash light emitting section 121b that emits flash light through the flash light emitting window 12b shown in FIG. 1 and a flash light control section 120b, a switch/LED 132b provided on the back side of the camera main unit, and the like operate under the control of the main unit CPU 100b.

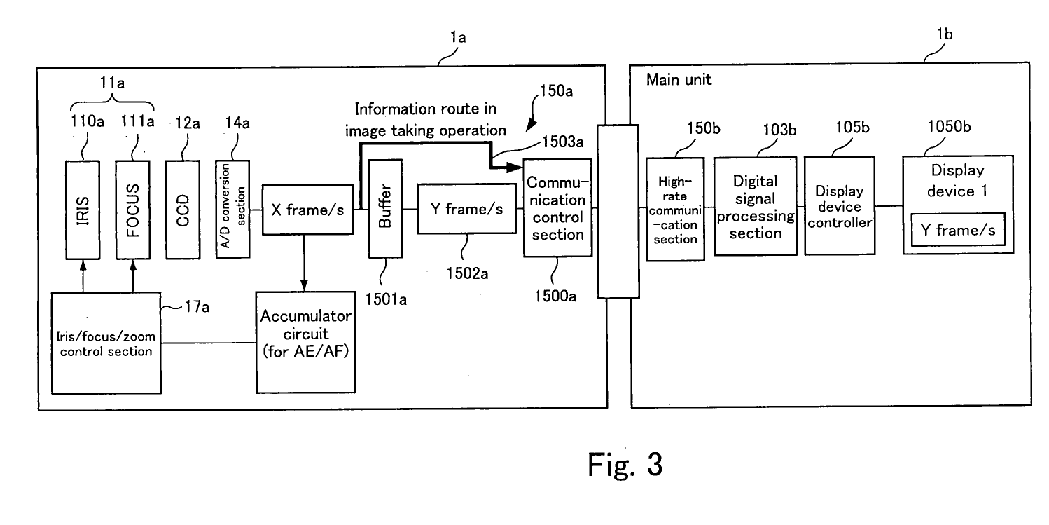

Now, a flow of a through image signal supplied from the camera head 1a to the camera main unit 1b and displayed by the display device 1050b of the camera main unit 1b will be described with reference to FIG. 3.

FIG. 3 is a diagram illustrating a flow of an image signal produced in the camera head 1a and supplied to the camera main unit 1b.

The image signal flow shown in FIG. 3 is a flow of an image signal from the camera head 1a to the camera main unit 1b through the high-rate communication sections 150a and 150b. FIG. 3 shows the same components as in FIG. 2, and the same components are denoted by the same reference numerals for the sake of clarity of correspondence between the drawings. Now, the flow of the image signal will be described shortly.

Object light, whose quantity is adjusted by an iris 110a in the image taking optical system 11a and whose focus is adjusted by a focusing lens 111a, is focused on the CCD 12a to form an image, the CCD 12a produces a through image signal representing the object, and the through image signal is supplied to the A/D conversion section 14a and then to the high-rate communication section 150a. The high-rate communication section 150a is composed of a communication control section 1500a, a buffer 1501a, a Y-frames/s conversion section 1502a, and a bypass route 1503a. When transmitting a through image signal, the through image signal of 300 frames/s, for example, is thinned out by buffering to 30 frames/s, the thinned through image signal is supplied to the Y-frames/s conversion section 1502a, the Y-frames/s conversion section 1502a converts the frame rate from X frames/s, the predetermined first frame rate, to Y frames/s, the predetermined second frame rate, and then, the through image signal is transmitted to the high-rate communication section 150b of the camera main unit via the communication control section 1500a. The through image signal is received at the high-rate communication section and supplied to the digital signal processing section 103b. Furthermore, the through image signal is supplied to the display device 1050b via the display device controller 105b, and the through image based on the through image signal is displayed on the display screen of the display device 1. If a static image signal is transmitted, the static image signal is transmitted at the frame rate of X frames/s to the camera main unit via the bypass route 1503a, without being supplied to the buffer 1501a and the Y frames/s conversion section 1502a.

With such an arrangement, the static image signal is supplied to the digital signal processing section 103b of the camera main unit at the predetermined first frame rate of X frames/s and processed into an image file in the digital signal processing section 103b, and the image file is stored in the memory card 108b in a short time. On the other hand, the through image signal is supplied to the display device 1050b after the frame rate is converted to a frame rate (Y frames/s) suitable for display on the display screen of the display device 1050b, 30 frames/s, for example, and the through image based on the through image signal is displayed on the display screen as if it is a moving image.

With such an arrangement, since the frame rate of the through image signal that is repeatedly transmitted is reduced to Y frames/s, power consumption of the battery is reduced, and occurrence of radiation noise is suppressed due to the reduction of power consumption.

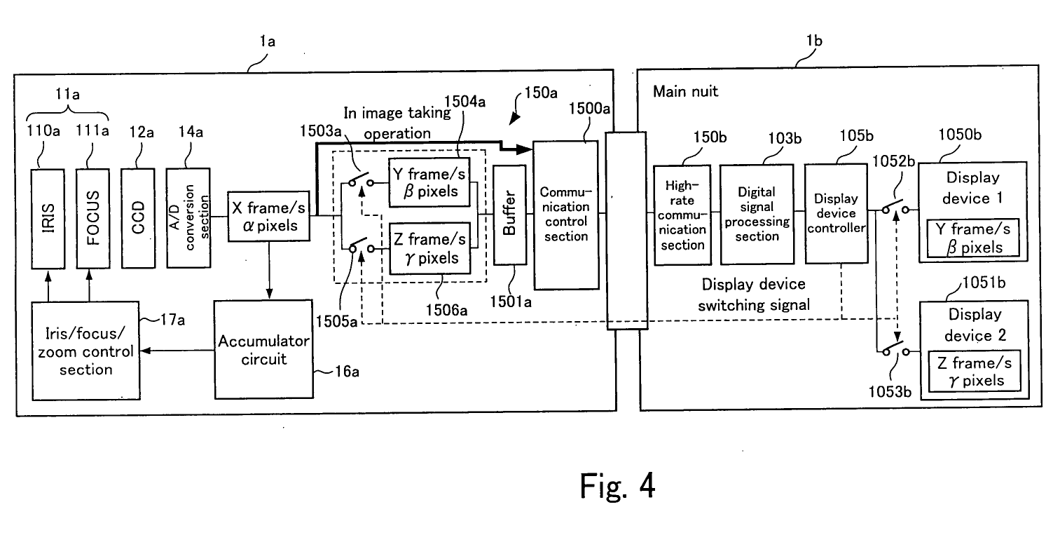

FIG. 4 shows another embodiment.

FIG. 4 shows an example in which plural types of display devices are disposed. A first display device 1 1050b is an LCD, and a second display device 2 1051b is a viewfinder.

The arrangement according to this embodiment is essentially the same as that shown in FIG. 3. However, since the display device 1 1050b and the display device 2 1051b differ from each other in hardware specification, the through image signal is supplied to the display device 1 1050b after the frame rate is converted from X frames/s to Y frames/s in a Y-frames-β-pixel conversion section 1504a, and the image signal is supplied to the display device 2 1051b after the frame rate is converted from X frames/s to Z frames/s in a Z-frames-γ-pixel conversion section 1506a. FIG. 4 shows that the number of pixels of the CCD is α, the number of pixels of the LCD is β, and the number of pixels of the viewfinder is γ. In order to accommodate such differences in number of pixels, in this example, the Y-frames-β-pixel conversion section 1504a and the Z-frames-γ-pixel conversion section 1506a are provided, there are provided switches 1503a and 1052b preceding the Y-frames-β-pixel conversion section 1504a and the display device 1 1050b, respectively, which operate in association with each other, and switches 1505a and 1053b preceding the Z-frames-γ-pixel conversion section 1506a and the display device 2 1051b, respectively, which operate in association with each other. With such an arrangement, the Y-frames/s-β-pixel conversion section 1504a supplies the through image signal to the display device 1 1050b, which is an LCD, at the frame rate of Y frames/s, and the Z-frames/s-γ-pixel conversion section 1506a supplies the through image signal to the display device 2 1051b, which is a viewfinder, at the frame rate of Z frames/s. In this example, the display controller on the main unit controls the switches so that the through image signal is supplied alternately to the display device 1 1050b and the display device 2 1051b.

With such an arrangement, the through image signal can be supplied alternately to the display device 1 1050b and the display device 2 1051b at frame rates of Y frames/s and Z frames/s, respectively, which are both lower than X frames/s. Therefore, the communication rate of the high-rate communication section can be reduced, the power consumption of the high-rate communication section can be reduced, and occurrence of radiation noise of the communication section can be suppressed due to the reduction of power consumption of the high-rate communication section.

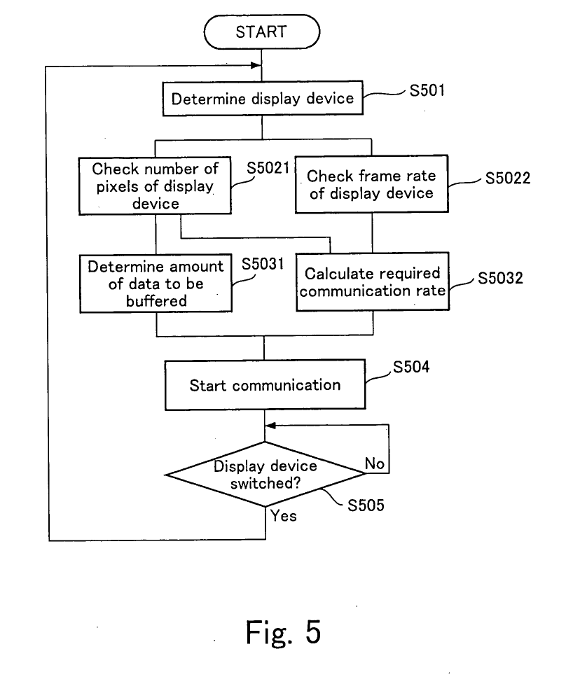

FIG. 5 is a flowchart showing a procedure of a processing performed by the display device controller 105b.

Once the power is turned on, the processing shown in the flowchart starts.

In step S501, it is determined whether a processing for the display device 1 or a processing for the display device 2 is to be performed. If it is determined that the processing for the display device 1 is to be performed, the processing for the display device 1 is performed, or if it is determined that the processing for the display device 2 is to be performed, the processing for the display device 2 is performed. That is, in step S501, the display device controller supplies a switching signal to each switch.

Then, in step S5021, the number of pixels of the display device 1 or 2 (α, β or γ) is checked, and simultaneously, in step S5022, the frame rate of the display device 1 or 2 (Y or Z) is checked.

Then, in step S5031, the amount of data to be buffered in the buffer 1501a is determined based on the number of pixel (α, β or γ) of the display device, and simultaneously, in step S5032, the communication rate required to display the object image on the display screen of the display device 1 1050b or the display device 2 1051b is calculated. In the calculation of the communication rate in step S5032, the communication rate required for displaying the through image signal on the display device is calculated based on both the frame rate checked in step S5021 and the number of pixels of the display device checked in step S5022.

Then, in step S504, the communication is started, and then, in step S505, the process is repeated while alternately switching between the display device 1 and the display device 2.

1. A camera system, comprising: a camera head having an image taking optical system and an image pickup device; and a camera main unit to which the camera head is removably attached and which receives an image signal from the camera head and performs a signal processing,
wherein the camera head has a signal reading section that reads an image signal from the image pickup device at a predetermined first frame rate and a signal transmission section that transmits the image signal to the camera main unit at a predetermined second frame rate that is lower than the first frame rate.

2. The camera system according to claim 1, wherein the camera head has a calculation section that performs at least one of exposure adjustment and focus adjustment based on the image signal read by the signal reading section at the first frame rate, and
the camera main unit has an image display section that displays an image based on the image signal transmitted by the signal transmission section at the second frame rate.

3. The camera system according to claim 2, wherein the camera main unit has a plurality of types of image display sections that display an image based on the image signal transmitted from the signal transmission section and a display section switching section that selects one of the plurality of types of image display sections that display the image, and
the signal transmission section transmits the image signal at the second frame rate, which is suitable for the image display section that displays the image selected by the display section switching section.

4. The camera system according to claim 1, wherein the signal transmission section transmits the image signal read by the signal reading section at the same rate as the reading rate of the signal reading section by thinning out the image signal on a frame basis.

5. The camera system according to claim 1, wherein the signal transmission section has a buffer that thins out and buffers the image signal read by the signal reading section on a frame basis and transmits the image signal buffered in the buffer at a rate lower than the rate of reading of the image signal by the signal reading section.
